(19) United States
(12) Patent Application Publication
(10) Pub. No.: US 2006/0020494 A1
(43) Pub. Date: Jan. 26, 2006

(54) System and method for managing the administering of medications

(76) Inventors: Joe Paul Gallo, Sanger, TX (US); Sue A. Gallo, Sanger, TX (US)

Correspondence Address: David E. Orr, 4619 NE 39TH Avenue, Vancouver, WA, 98661, US

(21) Appl. No.: 10/897,790

(22) Filed: Jul. 23, 2004

(51) Int. Cl. G06Q 50/00

(52) U.S. Cl. 705/3; 705/2

(57) ABSTRACT

In a first aspect, the invention comprises a monitoring device, the monitoring device used by a caregiver or patient, the device storing and displaying information related to a patient's medication regimen. Using the monitoring device, a single caregiver can monitor and confirm the correct medication to be given, and also monitor and confirm the correct amounts of medication and the correct times medications are to be given. In a second aspect, the invention comprises a system and method for tracking failures to properly take medication and for tracking potential problems with medications and sending alerts to patients and caregivers when failures or problems are first known.

### RELATED APPLICATIONS

This application is related to and derives priority from U.S. patent application entitled A SYSTEM AND METHOD FOR MANAGING THE ADMINSTERING OF MEDICATIONS, which is incorporated herein by reference.

### FIELD

The present invention is related to devices and methods for managing the administration of medicines; more specifically the present invention is a system and method for controlling and monitoring the administration of drugs.

### BACKGROUND

A critical part of medical care involves the giving of medications to patients. It is well known that proper medicating requires timely administration, coupled with giving the correct amounts, using the correct pathways for administering.

In one study of hospitals the United States General Accounting Office concluded almost one-third of all hospital deaths resulted from errors committed by medical caregivers. A substantial portion of these deaths is caused by mistakes made in administering medications to patients. These medical mistakes involved giving the wrong medications, incorrect dosages or giving medications at the wrong times.

The Institute of Medicine issued a report concluding that medical errors kill 44,000 to 98,000 patients in U.S. hospitals each year. This means that more people die from medical errors than from motor vehicle accidents, breast cancer, or AIDS. There are many different problems that add to medical errors, such as when the communication between the doctor and their patients is lost, for example in giving of medications to a patient. A significant number of the problems occur when the detection of medical errors and shortages of both nurses and the latest medical equipment is suppressed.

Therefore, it is evident new systems and methods could curtail unnecessary deaths resulting from mistakes made giving medications.

It is well known that despite safeguards used by the FDA in granting approval for new medications, side effects and drug interactions—often fatal—are discovered only after the drug is released for use by patients.

Therefore, new systems and methods are needed to patients on medications when new information arises, the information related to potential problems resulting from their medications.

### SUMMARY

In recognition of the requirement for better control of administering medications to patients, herein is disclosed an invention having two aspects, both related to the control of giving medications to patients.

In a first aspect, the invention comprises a monitoring device, the monitoring device used by a caregiver or patient, the device storing and displaying information related to a patient's medication regimen. Using the monitoring device, a single caregiver can monitor and confirm the correct medication to be given, and also monitor and confirm the correct amounts of medication and the correct times medications are to be given. It will be seen the monitoring device is invaluable to the process of giving the correct medication, in the correct dosages at the correct times, and giving medications using the correct pathway for delivery into the patient's body.

In a second aspect, the invention comprises a system and method for tracking potential problems with medications and sending alerts to patients and caregivers when problems are first known.

The invention will be seen to have several objectives and benefits, among them being the invention prevent deaths from errors made in administering medications.

A second objective is the system is easy to use.

A third objective is the invention provides information to the patient and caregiver at the earliest possible moment.

The foregoing and other objects and advantages will appear from the description to follow. In the description reference is made to the accompanying drawings, which form a part hereof and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the invention.

### BRIEF DESCRIPTION OF DRAWINGS

FIG. 1 is a diagram of the functionality of a first aspect of the invention—a monitoring device for monitoring the administering of medications.

FIG. 2 is a block diagram of the components of the monitoring device.

FIG. 3 is a flow chart of a first embodiment of a second aspect of the invention—a method for generating alerts related to problems with giving medications.

FIG. 4 is a flow chart of a second embodiment of the second aspect of the invention—a method for generating alerts related to problems with giving medications.

FIG. 5 is a flow chart of a third embodiment of the second aspect of the invention—a method for generating alerts related to problems with giving medications.

### DETAILED DESCRIPTION

### A First Aspect of the Invention

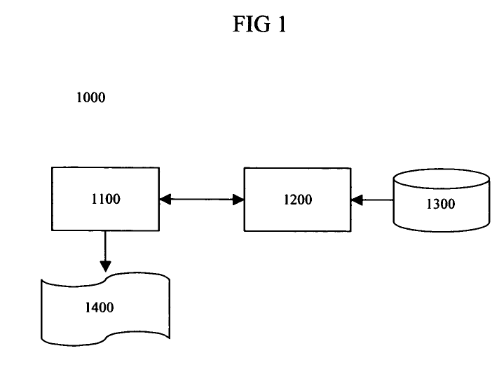

With reference to FIG. 1, the first aspect of the invention is a monitoring device 1100 for storing, updating and querying information and data 1400 related to patient medications. Information and data such as medication data and medicating regimens are uploaded and downloaded by the monitoring device 1100 to and from a server 1200 having a database 1300. A caregiver or a patient uses the device to manage medicating the patient.

The monitoring device can be operated by a caregiver, such as a nurse or physician's assistant while giving medications to a patient in a clinic or hospital. Or the device can be used by a person taking medications, whereby the device alerts the person as to the correct time to take medications, as well as alerting the person of correct medicines and dosages to take. The device may also alert a person responsible for the patient.

### Computing Framework for Implementing the First Aspect of the Invention

The computing framework for an exemplary embodiment of the monitoring device comprises the processing, storage, communications and display mechanisms used by a patient or caregiver to monitor to confirm the administering of medications to a patient.

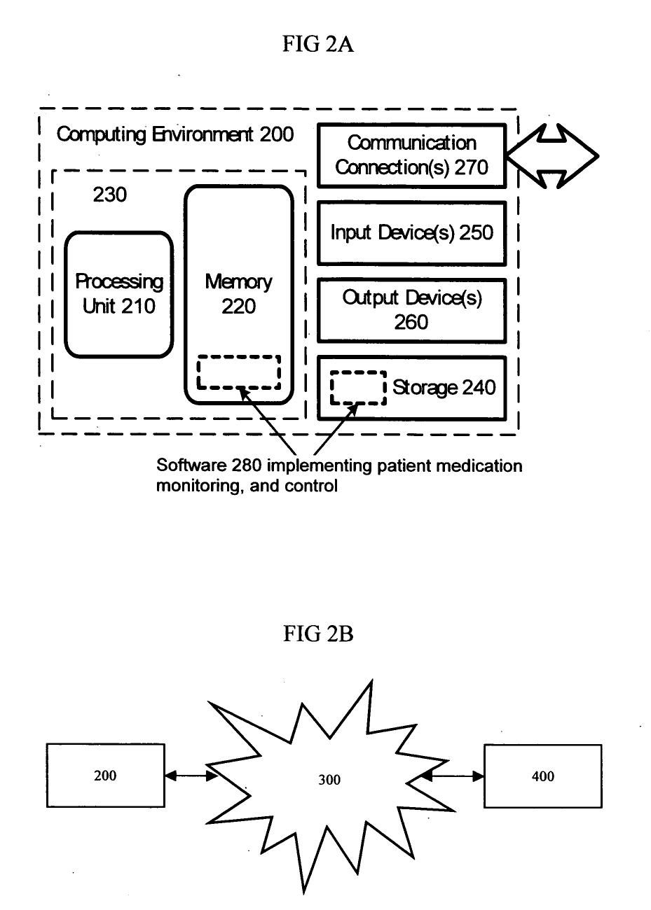

FIG. 2A illustrates an example of a suitable computing framework 200 in which an embodiment of the monitoring device may be implemented. The computing framework 200 is not intended to suggest any limitation as to scope of use or functionality of the invention, as the present invention may be implemented in diverse general-purpose or special-purpose computing frameworks.

With reference to FIG. 2A, the monitoring device 200 includes at least one processing unit 210 and memory 220. In FIG. 2A, this most basic configuration 230 is included within a dashed line. The processing unit 210 executes computer-executable instructions and may be a real or a virtual processor. In a multi-processing system, multiple processing units execute computer-executable instructions to increase processing power. The memory 220 may be volatile memory (e.g., registers, cache, RAM), non-volatile memory (e.g., ROM, EEPROM, flash memory, etc.), or some combination of the two. The memory 220 stores software 280 implementing algorithms required to implement and practice the invention, particularly the execution of software modules than maintain, display, update and query patient mediction records stored within the monitoring device.

A monitoring device for other features of the invention may have additional features. For example, the monitoring device 200 includes storage 240, one or more input devices 250, one or more output devices 260, and one or more communication connections 270. An interconnection mechanism (not shown) such as a bus, controller, or network interconnects the components of the monitoring device 200. Typically, operating system software (not shown) provides an operating framework for other software executing in the monitoring device 200, and coordinates activities of the components of the monitoring device 200.

The storage 240 may be removable or non-removable, and includes magnetic disks, magnetic tapes or cassettes, CD-ROMs, DVDs, or any other medium which can be used to store information and which can be accessed within the computing framework 200. The storage 240 stores instructions for software 280 and data.

In particular the storage is used to receive and store medication records for at least one patient or person taking medicine. Medication records may be stored in a fashion to permit query and retrieval of said records, wherein query and retrieval is predicated upon data entry by the operator of the device. Data entry can be, but is not limited to, information pertaining to medications, medication schedules and protocols, routes or paths of medication, patient identification, caregiver identification, identification and means of contacting a responsible third party, date and time, patient room number, identification of medications, complete and uncompleted medication orders, and other data to be stored in the device.

Routes of medication include the pathway or means by which medication is introduced to the patient.

The input device(s) 250 may be a touch input device such as a keyboard, mouse, pen, or trackball, a voice input device, a scanning device, or another device that provides input to the computing framework 200.

For audio or video, the input device(s) 250 may be a sound card, video card, TV tuner card, or similar device that accepts audio or video input in analog or digital form.

Input comprises entries made by the operator of the monitoring device and includes, but is not limited to: (a) identification information related to the device operator, or the patient or the medication, route of application, or time and date; (b) information required for querying records stored in the monitoring device; (c) device status requests; (d) passwords and other security information; (e) queries for retrieving patient medication records; (f) patient status, device status and diagnostic information; (g) medication records; (g) data related to medications given to a patient—either particular edpisodes of medicating, or historical data related to a medication regimen.

The output device(s) 260 may be a display, printer, speaker, or another device that provides output from the monitoring device 200. Output from the monitoring device include, but is not limited to: (a) responses to status queries; (b) displays of patient medication data, schedules, routes and so forth; (c) administrative and reporting information related to patient medications; and audible or visual alarms for alerting a user of the device.

The communication connection(s) 270 enable the carrier which is modulated by the transmitter and demodulated by the receiver of the monitoring device. The communication medium conveys information such as computer-executable instructions, compressed audio or video information, or other data in a modulated data signal, such as medication records transmitted from a server or database.

Communications connections are made between the device and a computer network, which is operated by a hospital or is operated by a pharmacy. The computer network communicates with the device and downloads medication records, and uploads data related to episodes of medication. Communications may also be made between the device, through an intermediary, to alert a responsible third party, when the patient fails to take prescribed medications.

A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The invention can be described in the general context of computer-readable media. Computer-readable media are any available media that can be accessed by the monitoring device. By way of example, and not limitation, with the monitoring device 200, computer-readable media include memory 220, storage 240, communication media, and combinations of any of the above.

The system and method of the invention can be described in the general context of computer-executable instructions, such as those included in program modules, being executed in a computing framework on a target real or virtual processor. In the disclosed aspects of the invention, program modules are executed for: (a) Loading patient medication records into the memory of the monitoring device. Patient medication records include data pertaining to the patient's identification, the names of medications taken, amounts taken, and times medications are to be given, plus other data entered by the patient or caregiver. (b) Retrieving one or more patient medication records, wherein retrieval is controlled by patient identification, caregiver identification, medication given and time of day, or other identifying data. (c) Processing and updating historical medication records and other data stored in the monitoring device; (d) Responding to, editing and accepting operator input; (e) Storing and displaying data entered by the operator; (f) Formatting and displaying data and records stored in the monitoring device; (g) sending messages and alerts to parties other than the patient or the person operating the device.

Generally, program modules include routines, programs, libraries, objects, classes, components, data structures, etc. that perform particular tasks or implement particular abstract data types. The functionality of the program modules may be combined or split between program modules as desired operations performed by a computer, and should not be confused with acts performed by a human being. The actual computer operations corresponding to these terms vary depending on implementation.

The program modules are written in a programming language selected for the particular computer used in the apparatus; the language selected from C, C++, Visual BASIC, Java, assembly language, Fortran and so forth.

It will be appreciated that functions or processes that are described in terms of software can be implemented in hardware devices such as ASICs (application specific integrated circuits), FPGA (field programmable gate arrays) or the like. Similarly, functions or processes that are described as hardware devices can also be implemented in software.

With reference to FIG. 2B, the monitoring device is connected to a network, such as the Internet 300, the device 200 receiving information from a server system 400. Patient and medication information is received from the server 400, and information is transmitted to the server 400 from the monitoring device 200, through the network 300.

With reference to FIG. 2B, the monitoring device receives medication records from a hospital computer network, or from a pharmacy computer system. The hospital computer network or pharmacy computer system receives input from the monitoring device, the input comprising episodes of taking medication by the patient.

### Operation of the Monitoring Device

The monitoring device is either loaded with patient medication records from a connection to a server or the patient medication records are entered into the device by one of the input means attached to the monitoring device.

In a first example, patient medication records are loaded by a network from a hospital computer system.

In a second example, patient medication records are loaded by a network from a pharmacy computer.

In a first mode of operation, a timer in the monitoring device causes the device to generate audible alarms and displays, at the times when medications are to be given. An example of the first mode of operation occurs when a pharmacy has entered medication records into the monitoring device in order to assist a person using the device to take the correct medications in the correct amounts and at the correct times. The audible alarm causes the person to attend to the device, and to read the display, which displays the medication regimen for the current time. In the first mode of operation, the device is programmed to require input from the operator, the input related to confirmation the required medications, dosages and times of dosages have been taken by the person.

In a second mode of operation, the operator of the device may query the device to obtain a list or summary of all patients to receive medications. The list or summary is displayed by patient, or type or medication, or route of medication, or by time and date or by room number, the type of display selectable by the operator.

The operator uses the device in conjunction with the administering of medications to determine the type, time, amount and route of application for each patient; the determination results in the device displaying the desired information, identifying the patient and the patient's current location, if required. As each patient is administered medications the display is used to display, confirm or check the actual medicating regimen for each patient. After each administration, the operator enters information pertaining to the actual medication application into the device, so that summary or audit records can be produced by the device or summary information or audit records can be uploaded to a patient medical record system.

### A Second Aspect of the Invention—First Embodiment

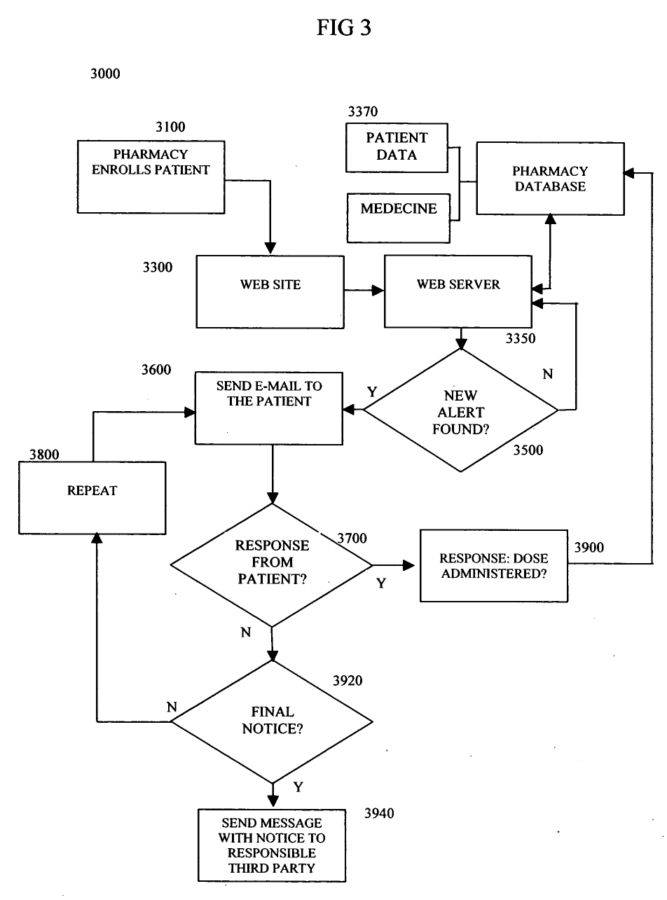

With reference to FIG. 3, a second aspect of the invention comprises a system and method 3000 for generating alerts to patients or caregivers, the alerts pertaining to possible problems resulting from the giving of medications. FIG. 3 shows the steps used by the system and method 3000 of the invention, as the system and method 3000 used by a pharmacy to send alerts to a patient taking medication.

With reference to FIG. 3, a pharmacy technician enrolls a patient into the system 3100, information entered by the pharmacy technician stored on a server 3350 programmed to execute the method of the present invention. The pharmacy technician enters data through a network, for example through a web-site 3300. The pharmacy technician 3100 also enters dosage amounts and times and other information related to the medication.

The server at the web-site 3350 is also programmed to receive other inputs, such as newly discovered side effects from drugs as well as drug interactions. Data pertaining to medications and medicating regimens are stored in a database 3370 attached to the server 3350.

The server at the web-site 3350 is programmed to check the medications prescribed for each enrolled patient; the server 3350 checking for new side effects and drug interactions.

An alert 3500 is generated by the server when either (a) the user of the device has failed to enter confirmation of medications given according a regimen stored in the monitoring device and the server, or the confirmation has not been received by the server, or (b) a problem, such as a drug interaction, has been stored on the server, the drug interaction related to a medication taken by a person using the device.

If a reason for an alert 3500 is found, the server 3350 sends a notice by e-mail 3600 to the patient. If the patient fails to respond to the alert notice 3700, the server repeats the e-mail 3800, sending up to three e-mail notices, however the number three is arbitrary and may be changed.

If the patient fails to respond on the third e-mail notice 3920, the alert is sent to a responsible third party 3940.

If the patient responds by the third e-mail, the response is recorded as to whether the patient has taken a recent dosage, 3900, with appropriate medical intervention taken accordingly.

### A Second Embodiment of the Second Aspect of the Invention

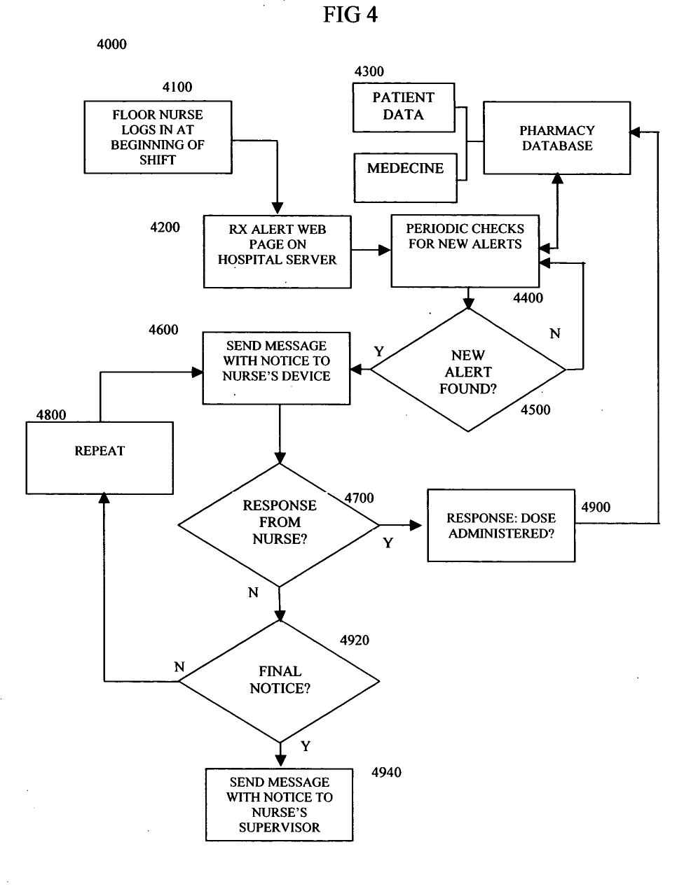

With reference to FIG. 4, a second embodiment 4000 of the second aspect of the invention comprises a system and method 4000 for generating alerts to patients or caregivers, the alerts pertaining to possible problems resulting from the giving of medications. FIG. 4 shows the steps used by the system and method 4000 of the invention, as the system and method 4000 used by a nursing staff to handle alerts relevant to a patient taking medication.

With reference to FIG. 3, a floor nurse enrolls a patient into the system 4100, information entered by the floor nurse stored on a server 4350 programmed to execute the method of the present invention. The floor nurse enters data through a network, through a web-site 4200. The floor nurse 4100 also enters dosage and other information related to the medication.

The server at the web-site 4350 is also programmed to receive other inputs, such as newly discovered side effects from drugs as well as drug interactions.

The server at the web-site 4350 is programmed to check the medications prescribed for each enrolled patient; the server 4350 checking for new side effects and drug interactions.

If a reason for an alert is found 4400, the server 4350 sends a notice by e-mail to a personal electronic device of a nurse responsible for the patient's care 4500. If the responsible nurse fails to respond to the alert notice 4700, the server repeats the alert message 4800, sending up to three alert notices, however the number three is arbitrary and may be changed.

If the responsible nurse fails to respond on the third alert notice 4920, the alert is sent to the responsible nurses supervisor 4940.

If the responsible nurse responds by the third alert message, the response is recorded as to whether the patient has taken a recent dosage, 4900, with appropriate medical intervention taken accordingly.

### A Third Embodiment of the Second Aspect of the Invention

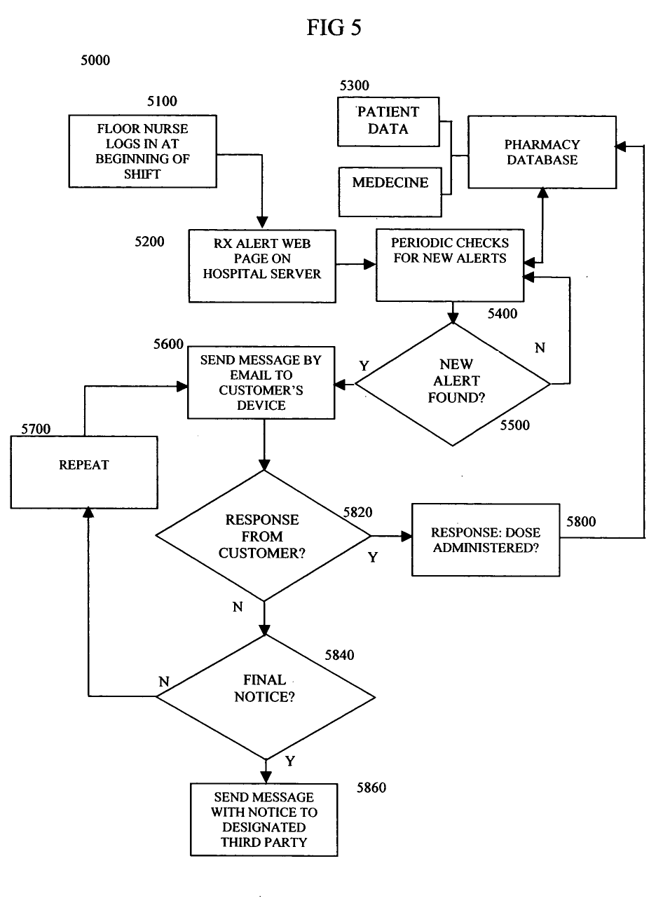

With reference to FIG. 5, a third embodiment 5000 of the second aspect of the invention comprises a system and method 5000 for generating alerts to patients or caregivers, the alerts pertaining to either failure to confirm taking medications or to possible problems resulting from the giving of medications. FIG. 5 shows the steps used by the system and method 5000 of the invention, as the system and method 5000 used by a customer to receive alerts relevant to a patient taking medication.

With reference to FIG. 5, the customer enrolls a patient into the system 5100, information entered by the customer stored on a server 5300 programmed to execute the method of the present invention. The customer enters data through a network, through a web-site 5200. The customer 5100 also enters dosage and other information related to the medication.

The server at the web-site 5300 is also programmed to receive other inputs, such as newly discovered side effects from drugs as well as drug interactions.

The server at the web-site 5300 is programmed to check the medications prescribed for each enrolled patient; the server 5300 checking for new side effects and drug interactions.

If a reason for an alert is found 5400, the server 5300 sends a notice by e-mail to a customer's electronic device 5600. If the customer fails to respond to the alert notice 5700, the server repeats the alert message 5820, sending up to three alert notices, however the number three is arbitrary and may be changed.

If the customer fails to respond on the third alert notice 5840, the alert is sent to a designated third party 5860.

If the customer responds by the third alert message, the response is recorded as to whether the patient has taken a recent dosage, 5800, with appropriate medical intervention taken accordingly.

### DISCLOSURE SUMMARY

Having described exemplary embodiments of the two aspects of the invention, it will be appreciated that each embodiment can be modified in arrangement and detail without departing from the principles of the inventive conception and implementation. It should be understood that the computer programs, processes, equipment used, or methods described herein are not related or limited to any particular type of computing framework, unless indicated otherwise. Various types of general purpose or special computing frameworks may be used with or perform operations in accordance with the teachings described herein. Elements of the illustrative embodiments described as software may be implemented in hardware and vice versa.

In view of the many possible embodiments to which the principles of my invention may be applied, we claim as our invention such embodiments as may come within the scope and spirit of the following claims and equivalents thereto.

What is claimed is:

1. A monitoring device for monitoring medications given to a patient, the device comprising:
a storage means for storing information related to a patient and for storing information related to medications taken by the patient;
input means for inputting said information related to the patient and for inputting said information related to the patient's medications;
input means for receiving input from an operator of the monitoring device; and
output means for displaying said patient information and for displaying said medication information;
whereby patient information and medication information is displayed, said displays used to confirm medications given to the patient.

2. The monitoring device of claim 1, wherein the operator is the patient, the patient inputting whether the patient has taken the medications.

3. The monitoring device of claim 2, wherein the information displayed is a message related to an alert when the patient fails to input whether the patient has taken the medications.

4. A method for sending alerts to a caregiver, the alerts related to problems with medications taken by a patient, the method comprising:
storing a record related to a patient's medications;
storing a record related to medication side-effects;
generating an alert when the medication in a patient's medication record is the same medication stored in a medication side-effects record; and
sending an alert message.

5. A method for sending alerts to a caregiver, the alerts related to problems with medications taken by a patient, the method comprising:
storing a record related to a patient's medications;
storing a record related to a medication interaction;
generating an alert when the medication in a patient's medication record is the same medication stored in the medication interaction record; and
sending an alert message.

6. The method of claim 5, wherein the alert message is sent over a network.

7. The method of claim 6, wherein the alert message is sent to a third party responsible for the patient.
